(19) United States
(12) Patent Application Publication
(10) Pub. No.: US 2009/0164709 A1
(43) Pub. Date: Jun. 25, 2009

(54) SECURE STORAGE DEVICES AND METHODS OF MANAGING SECURE STORAGE DEVICES

(75) Inventors: Byoung-Kook Lee, Gyeonggi-do (KR); Ji-Soo Kim, Gyeonggi-do (KR); Seon-Taek Kim, Gyeonggi-do (KR); Won-Hee Cho, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/328,553

(22) Filed: Dec. 4, 2008

(30) Foreign Application Priority Data
Dec. 21, 2007 (KR) 2007-135380

(51) Int. Cl. G06F 12/00; G06F 13/00

(52) U.S. Cl. 711/103; 711/162; 711/170; 711/E12.001; 711/E12.002; 711/E12.092

(57) ABSTRACT

Methods of managing a secure area in a secure storage device include conducting an authentication process between a host and the secure storage device while modifying a size of the secure area, backing up secure data to the host from the secure area after completing the authentication process, updating management information to modify a size of the secure area, and storing the secure data, which has been backed up to the host, into the secure area that is modified in size. Related storage devices are also disclosed.

### CROSS-REFERENCE TO RELATED APPLICATION

This U.S. non-provisional patent application claims priority under 35 U.S.C. §119 to Korean Patent Application No. 10-2007-0135380 filed on Dec. 21, 2007, the disclosure of which is incorporated herein by reference.

### BACKGROUND

The present invention relates to memory systems having secure storage devices and methods for managing secure areas thereof.

Secure areas are usually provided in nonvolatile memories for protecting secure data from access thereto by arbitrary or unauthorized users. Such secure areas are arranged to be accessible only through a legal authentication process by trusted entities, such digital rights management (DRM) agents. Hence, secure areas are hidden to normal users as inaccessible regions in nonvolatile memory devices.

FIG. 1 is a block diagram of a generic nonvolatile memory system including a secure area. Referring to FIG. 1, in order to provide a secure area, a specific address region is established as the secure area 7 in a nonvolatile memory 5. The secure area 7 is accessible only by an internal firmware, such as a secure CMD handler 3, but inaccessible from an external interface.

Considering practical contents that are stored in the secure storage device, even a single item of content (e.g., an MP3 file) may be associated with a number of restrictions, such as copyrights.

Traditionally, the secure area 7 has a fixed size. If the secure area 7 is filled with secure data, it may not be possible to store additional secure data even if the nonvolatile memory 5 has additional storage space as a whole. Furthermore if the secure area 7 is designed to have a larger size than necessary, the user area 8 must be made smaller, which can inconvenience the user.

### SUMMARY

Embodiments of the present invention provide methods for managing a secure area in a secure storage device, so that a size of the secure area can be modified safely and flexibly based on user requirements.

Some embodiments of the present invention provide methods of managing a secure area in a storage device. The methods include conducting an authentication process between a host and the secure storage device in preparation for modifying a size of the secure area, backing up secure data to the host from the secure area after completing the authentication process, updating management information relative to the secure area to modify a size of the secure area, and storing the secure data, which was backed up to the host, into the secure area that is modified in size.

In some embodiments, modifying the size of the secure area is carried out in response to a request by a user and/or is performed automatically in accordance with a memory management policy.

In some embodiments, the authentication process between the host and the secure storage device is carried out by a cryptographic protocol.

In some embodiments, data is backed up to the host from the user area in preparation for modifying the size of the secure area.

In some embodiments, the methods further include formatting the modified secure area after updating the management information. In some embodiments, the secure storage device formats the modified secure area.

In some embodiments, backing up the secure data includes encoding the secure data and transferring the encoded secure data to the host. In some embodiments, the encoded secure data is decoded and stored in the modified secure area.

Further embodiments of the present invention provide secure storage devices including a flash memory with a secure area, and a secure memory controller that is configured to control the flash memory and to enable access to the secure area based on authentication with a host.

In some embodiments, the secure memory controller includes a secure flash translation layer module. The secure flash translation layer module may include a host interface layer that receives a request from a host, a trusted entity that conducts an authentication process through a cryptographic protocol with the host if the request is for secure data, an access control layer that permits the trusted entity to access the secure area if the authentication process is carried our legally, and a flash translation layer that conducts reading and writing operations with an address and data, which are transferred from the trusted entity, based on mapping information about the secure area.

In some embodiments, the secure flash translation layer informs the host that it is not possible to access the secure area if the authentication process is not successful.

In some embodiments, the trusted entity of the secure flash translation layer software is configured to authenticate a trusted entity of the host by means of the cryptographic protocol.

In some embodiments, the trusted entity of the secure flash translation layer module includes a key storage layer that stores a cryptographic key used for the cryptographic protocol, and a secure file system that formats the secure area.

In some embodiments, in preparation for modifying a size of the secure area, the authentication process is carried out between the host and the trusted entity by means of the cryptographic protocol.

In some embodiments, modifying the size of the secure area is performed in response to a request of a user for modification that is transferred from the host.

In some embodiments, modifying the size of the secure area is performed in response to a request for modification that is automatically transferred from the host.

Methods of managing a secure storage device including a secure area and a user area according to further embodiments include storing management information regarding sizes of the secure area and the user area in a meta area of the secure storage device, and modifying the management information in the meta area to resize the secure area and the user area in response to a request from a host. The methods may further include performing an authentication process between the host and the secure storage device in preparation for modifying the size of the secure area. The methods may further include backing up secure data stored in the secure area to the host after successfully completing the authentication process, and storing the secure data, which was backed up to the host, into the secure area after resizing the secure area.

According to some embodiments, it is possible to vary a size of the secure area in response to user requirements. Furthermore, secure data in the secure area may be backed up safely using a cryptographic protocol.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a block diagram of a nonvolatile memory system including a secure area;

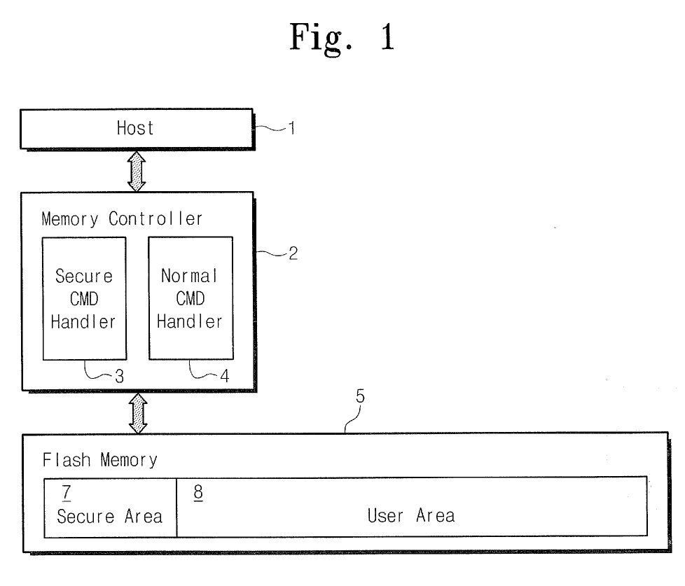

FIG. 2 is a block diagram of a memory system including a secure storage device according to some embodiments of the present invention;

FIG. 3 is a diagram showing an organization of a memory cell array in the flash memory of FIG. 2;

FIG. 4 is a block diagram showing an architecture of a secure flash translation layer software in accordance with some embodiments of the present invention;

FIG. 5 is a block diagram showing a memory system equipped with the secure flash translation layer software in accordance with some embodiments of the present invention;

FIG. 6 is a block diagram showing normal operation paths of the secure flash translation layer software in accordance with some embodiments of the present invention; and

FIG. 7 is a flow chart of a memory system in accordance with some embodiments of the present invention.

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

In a secure storage device according to some embodiments of the present invention, a size of a secure area can be varied in response to user needs and/or a memory management policy. A secure flash translation layer module (hereinafter, referred to as “secure FTL module”) according to some embodiments of the present invention is configured to enable an authentication process with a host during a reading or writing operation and/or before changing a size of the secure area. The secure FTL module can be implemented as software, firmware and/or microcode in the secure storage device 40. A secure FTL module according to some embodiments of the present invention can work to increase the safety of secure data while changing a size of the secure area.

Exemplary embodiments of the present invention will now be described in conjunction with the accompanying drawings.

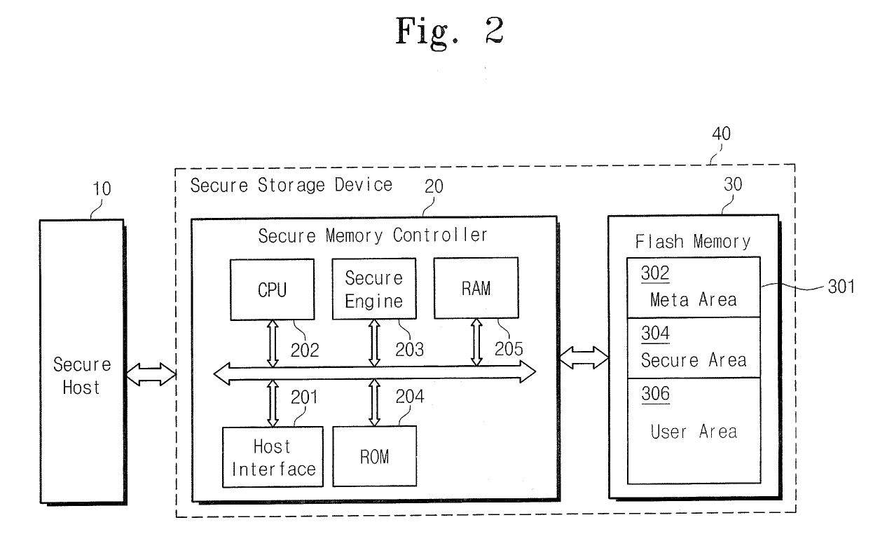

FIG. 2 is a block diagram of a memory system including a secure storage device 40 according to some embodiments of the present invention. Referring to FIG. 2, the memory system includes a secure host 10, a secure memory controller 20, and a flash memory 30. The memory system is configured to enable the host 10 to access a secure area 304 of the flash memory 30 by way of legal authentication with the secure memory controller 20. In the memory system according to some embodiments of the present invention, the secure host 10 is able to vary a size of the secure area 304 of the flash memory 30. The storage unit shown in FIG. 2 includes the flash memory 200. However, the present invention is not restricted to a flash memory. Rather, a storage unit according to some embodiments of the present invention may be implemented using other kinds of nonvolatile memory, such as magnetic random access memory (MRAM) and/or phase-changeable RAM.

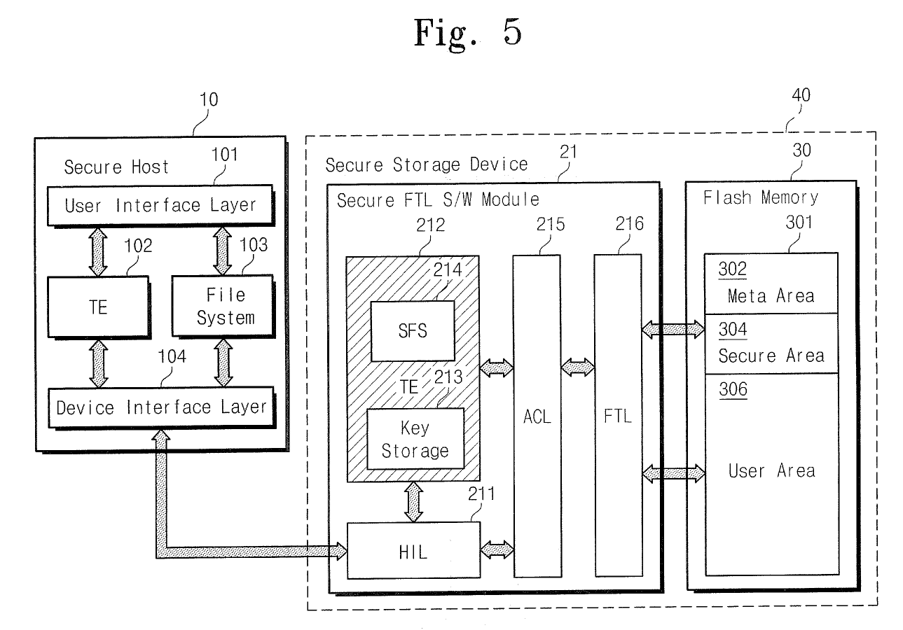

The secure host 10, which uses the secure storage device 40 as a storage unit, may be a personal computer, a mobile phone, a camera, or other type of electronic device. In particular, a secure host 10 according to some embodiments of the present invention may access the secure area 304 of the flash memory 30 by way of a legal authentication process with the secure memory controller 20. The secure host 10 will be described in more detail with reference to FIG. 5. A communication method between the secure host 10 and the secure storage device 40 may be associated with a protocol for a memory card, such as secure digital (SD) card or multimedia card (MMC), or a protocol designed for communications with a mass storage device, such as advanced technology attachment (ATA) or serial ATA (SATA).

The secure memory controller 20 communicates with the flash memory 30 in response to a request from the secure host 10. The secure memory controller 20 is configured to conduct legal authentication with the secure host 10. As shown in FIG. 2, the secure memory controller 20 includes a host interface 201, a central processing unit (CPU) 202, a secure engine 203, a read-only memory (ROM) 204, and a random access memory (RAM) 205. The secure engine 203 conducts encoding/decoding operations for legal authentication with the secure host 10, and conducts encryption of user data and decryption of data stored in the secure area 304. The RAM 205 is used for temporarily storing data that is needed in an operation of the secure memory controller 20. The ROM is used for storing software that is needed in an operation of the secure memory controller 20. The secure memory controller 20 shown in FIG. 2 is just an embodiment according to the present invention. The secure memory controller 20 may be implemented in various forms, being capable of conducting legal authentication with the secure host 10.

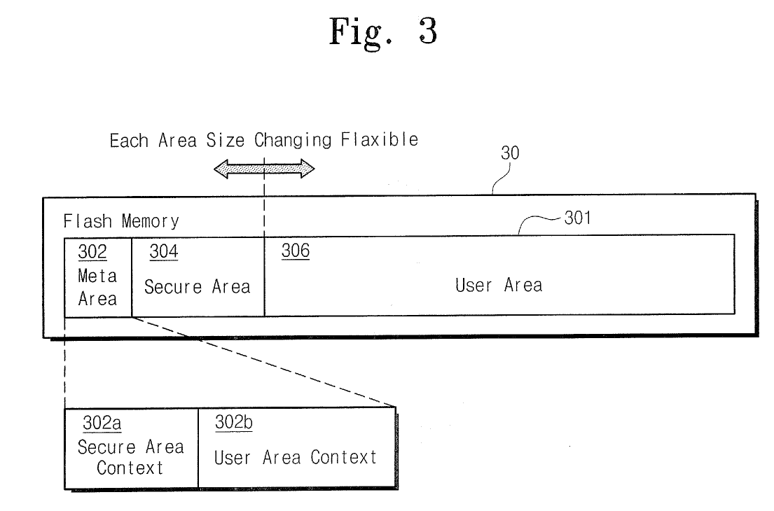

The flash memory 30 includes a memory cell array 301. The memory cell array 301 is divided into a meta-area 302, the secure area 304, and a user area 306. A size of the secure area 304 is variable in accordance with a request of the secure host 10, which will be discussed in more detail in conjunction with FIG. 3.

FIG. 3 is a diagram showing an organization of the memory cell array 301 in the flash memory 30. Referring to FIG. 3, the meta-region 302 stores information (e.g., mapping tables of the areas 302, 304, and 306) necessary for managing the flash memory 30. Secure area context information 302a for managing the secure area 304 and user area context information 302b for managing the user region 306 are controlled by a flash translation layer (FTL) software. Hence, a user cannot normally access the meta-area 302.

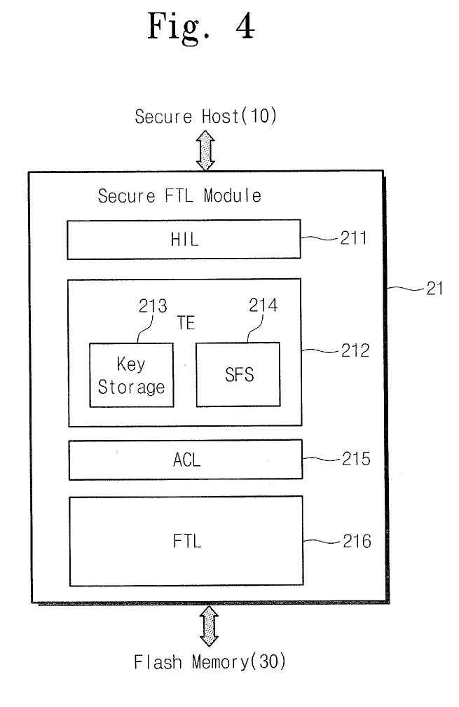

FIG. 4 is a block diagram showing the architecture of the secure FTL software in accordance with some embodiments of the present invention. Referring to FIG. 4, the secure FTL module 21 includes a host interface layer 211, a trusted entity 212, an access control layer (ACL) 215, and an FTL 216.

The trusted entity 212 includes a key storage layer 213 and a secure file system 214. The trusted entity 212 conducts authentication and secure communication by means of a cryptographic protocol so as to exchange secure data with the secure host 10. Cryptographic keys necessary for authentication and cryptographic communication may be reserved in the key storage layer 213. A secure file system (SFS) 214 provides a file system that enables the trusted entity 212 to directly write/read data into/from the secure area 304. The ACL 215 controls the trusted entity 212 to legally access the secure area 34 by way of the SFS 214, and controls the secure host 10, for which there is no authentication process at the same time, to be prohibited to access the secure area 204.

The FTL 216 controls the flash memory 30 to operate as a block unit of the secure host 10. Namely, the FTL 216 is used for providing a linear space to the flash memory 30 so as to enable reading/writing operations in units of sectors, such as in a conventional hard disk drive. For the purpose of enhancing usability, reliability, and performance of the flash memory 30, the FTL 216 can perform functions, such as mapping a logical address into a physical address, processing a bad block, and/or conducting an optimizing operation.

FIG. 5 is a block diagram showing a memory system equipped with the secure FTL module 21 in accordance with some embodiments of the present invention. Referring to FIG. 5, the memory system includes the secure host 10 and the secure storage device 40. The secure host 10 according to the present invention includes a trusted entity (TE) 102 for conducting secure communication through authentication with the secure storage device 40.

The secure host 10 includes a user interface layer 101, the trusted entity 102, a file system 103, and a device interface layer 104. The secure storage device 40 includes the secure FTL module 21 and the flash memory 30. The secure FTL module 21 is same as that shown in FIG. 4 and the flash memory 30 is same as that shown in FIG. 3.

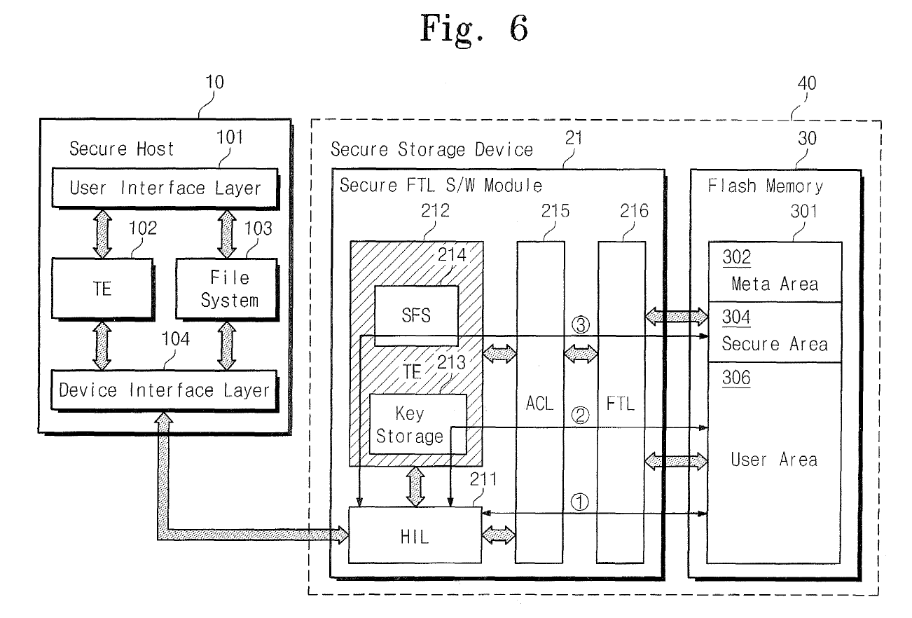

FIG. 6 is a block diagram showing normal operation paths by the secure FTL, software in accordance with some embodiments of the present invention. Referring to FIG. 6, the secure FTL module 21 generally has three operational paths. The first path is for normal data, and the second and third paths are for secure data. The second path is relevant to changing a size of the secure area 304 and the third path is relevant to reading/writing operations of the secure area 304.

First, the operation path for normal data is described as follows. Responding to a request by the file system 103 of the secure host 10, normal data is transferred to the host interface layer 211 through the device interface layer 104. The ACL 215 controls normal data to be transferred only to the user area 306. The ACL 215 prohibits data (i.e., normal data), which has not passed through the trusted entity 212, from accessing the secure area 304. Through the FTL 216, a logical address corresponding to normal data that has passed the ACL 215 is converted into a physical address and a writing operation is carried out to store the normal data in a physical location of the user area 306 corresponding to the physical address.

Next, the second operation path for secure data is described as follows. Hereafter will be described the operation path for secure data while changing a size of the secure area 304. If there is a request for changing a size of the secure area 304, secure data is first backed up to the secure host 10 from the secure area 304. During this, the secure data is encoded into a cryptographic key (a public key of asymmetrical encryption algorithm or a secret key of symmetrical encryption algorithm) of the secure storage device 40. The cryptographic data is transferred to the secure host 10. The data backed up to the secure host 10 may contain all information necessary for restoring a filing course, folder information, and so on. Additionally, data stored in the user area 306 is also backed up to the secure host 10. In this case, there is no need of executing a cryptography process operation with data and it conducts a normal reading operation to normal data.

The secure area 304 and the user area 306 may be modified in size by an option of a user, or automatically by a management policy. For instance, a user may be able to entirely eliminate the user area 306 from the memory cell array 301 so as to prohibit an arbitrary or unauthorized user from access thereto, utilizing the secure area 304 at maximum. Further, from comparing a practically used amount of the secure area 304 with the total size thereof, if the used amount is over a predetermined rate in the total size, a size of the secure area 304 may be also increased by a predetermined portion.

When sizes of the secure area 304 and the user area 306 are modified, the secure FTL module 21 updates information for managing the flash memory 30. For example, the secure FTL module 21 updates mapping tables for managing the secure area 304 and the user area 306. The ACL 215 controls access to addresses of the secure and user areas 304 and 306 by means of management information stored in the meta-area 302.

In modifying a size of the secure area 306, the FTL 216 formats file systems to the newly updated secure and user areas 304 and 306. The secure area 304 is formatted with the SFS 214 of the secure storage device 40, while the user area 306 is formatted with the file system 103 of the secure host 10. Here, formatting the secure area 304 means that it determines a size of the updated secure area 304 and a size and location of information for managing the secure area 304, and stores its initial value therein.

Secure and user data backed up to the secure host 10 are restored in the newly mapped secure and user areas 304 and 306. While restoring the backed-up secure data, it together restores secure data that is encoded into the cryptographic key (i.e., a secret key of symmetrical encryption algorithm) or a corresponding key (i.e., a secret key of asymmetrical encryption algorithm).

Finally, the third operation path for secure data is described as follows. Responding to a request for reading or writing secure data that is transferred from the secure host 10, the trusted entity 212 executes a process of authentification. After completing the authentication process, the SFS 214 managing the secure area 304 conducts a reading or writing operation to a specific address of the secure area 304. If data to be accessed to the file system 214 has been authenticated legally, the ACL 215 transfers the authorized data to the FTL 216. The FTL 216 executes a reading/writing operation with the transferred data in a physical location of the secure area 304 corresponding to the specific address.

In particular, the second and third paths are formed alter legally completing the authentication process between the trusted entity 103 of the secure host 10 and the trusted entity 212 of the secure storage device 40. If the authentication process is failed, any access to the secure area 304 is inhibited and there is an output of error message ‘ACCESS DENIED’ to the secure host 10.

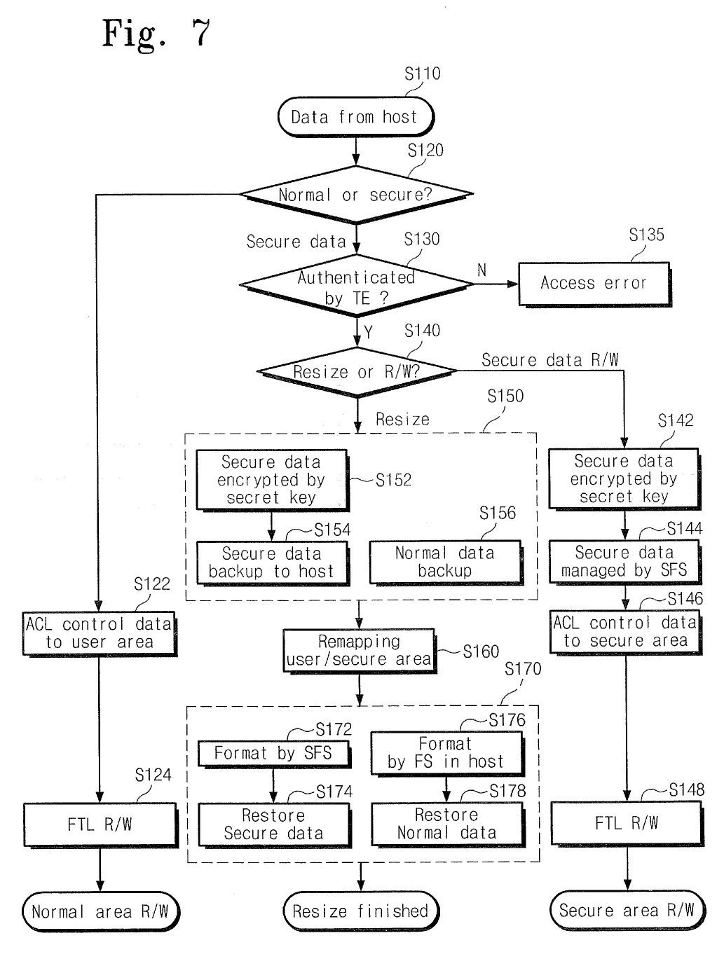

FIG. 7 is a flow chart illustrating operations of the memory system in accordance with some embodiments of the present invention. Referring to FIGS. 5 through 7, a data flow of the memory system will be described as follows. First, the secure storage device 40 receives data from the secure host 10 (step S110). The received data may be secure data involved in the secure area 304 or normal data involved in the user area 306. Whether the received data is normal data or secure data is determined by the host interface 211 in accordance with a request input thereto (step S120).

If an input request is for reading/writing normal data from/into the user area 306, the ACL 215 regards an address, which is correspondent with the normal data, as being assigned to the user area 306 and controls the host interface 211 to access the user area 306. Then, the FTL 216 proceeds to write/read data into/from a physical location of the user area 306 in correspondence with the address. Thereby, it completes the reading/writing operation with the normal data of the user area 306.

On the other hand, if an input request is for modifying a size of the secure area 304 or for reading/writing secure data from/into the secure area 304, the secure FTL module 21 determines whether an legal authentication process has been performed between the trusted entity 102 of the secure host 10 and the trusted entity 214 of the secure FTL module 21 (step S130). Unless there has been legal authentication between the trusted entity 102 of the secure host 10 and the trusted entity 214 of the secure FTL software 21, an error message ‘ACCESS DENIED’ is output to the secure host 10 (step S135). If there has been legal authentication between the trusted entity 102 of the secure host 10 and the trusted entity 214 of the secure FTL software 21, the host interface 211 determines whether input data is relevant to modifying a size of the secure area 304 or to reading/writing data from/into the secure area 304 (step S140).

From a result of the determination by the step S140, if the input data is secure data for reading/writing to the secure area 304, the secure data is encoded by means of a secret key (step S142). The secret key corresponding thereto is stored in the key storage layer 213. The encoded secure data is managed by the SFS 214 (step S144). The SFS generates an address in correspondence with the encoded secure data. The ACL 215 controls the trusted entity 213 to access the secure area 304 (step S146) if the trusted entity 213 has been legally authorized. Then, the FTL 216 proceeds to write/read data into/from a physical location of the secure area 304 in correspondence with the address. Thereby, it completes the reading/writing operation with the secure data of the secure area 304.

From a result of the determination by the step S140, if the input data is for modifying a size of the secure area 304, data stored in the secure and user areas 304 and 306 are first backed up to the secure host 10 (step S150). A backup procedure with secure data of the secure area 304 proceeds as follows. First, the secure data of the secure area 304 is encoded by a secret key (step S152). The encoded data is backed up to the secure host 10 (step S154). Next, a backup procedure with normal data of the user area 306 is carried out as same as a traditional reading operation (step S156). Thereby, the normal data is backed up to the secure host 10 from the user area 306. As arranged by FIG. 7, normal data is backed up to the secure host 10 from the user area 306 while modifying a size of the secure area 304. But, during a process of modifying a size of the secure area 304, there is no essential need of backing normal data up to the secure host 10 from the user area 306.

After backing-up data from the secure and user areas 304 and 306, the secure and user areas 304 and 306 are modified in size in response to a request of the secure host 10. This modified information is stored in the meta-area 302 of the flash memory 30. The ACL 215 controls access to the flash memory with reference to the modified information about sizes of the secure and user areas 304 and 306. Thereafter, in the FTL 216, mapping tables of the secure and user areas are updated to reflect the modified sizes of them respectively (step S160). These updated mapping tables are each stored in the meta-area 302 of the flash memory 30. The FTL 216 manages the secure and user areas 304 and 306 with reference to the mapping tables stored in the meta-area 302 of the flash memory 30.

After updating the mapping tables, the backed-up data are restored in the flash memory 30 (step S170). The secure area 304, now modified in size, is formatted by the SFS 214 (step S172), and the secure data backed up to the secure host 10 is restored in the formatted secure area 304 (step S714). The user area 306, which has been modified in size, is formatted by the file system 103 of the secure host 10 (step S176), and the normal data backed up to the secure host 10 is restored in the formatted user area 306 (step S718). Thereby, the procedure of modifying a size of the secure area 304 is completed.

In the drawings and specification, there have been disclosed typical embodiments of the invention and, although specific terms are employed, they are used in a generic and descriptive sense only and not for purposes of limitation, the scope of the invention being set forth in the following claims

What is claimed is:

1. A method of managing a secure area in a secure storage device, the method comprising:
conducting an authentication process between a host and the secure storage device in preparation for modifying a size of the secure area;
backing up secure data stored in the secure area to the host after completing the authentication process;
updating management information in the secure storage device to modify a size of the secure area; and
storing the secure data, which has been backed up to the host, into the secure area that has been modified in size.

2. The method as set forth in claim 1, wherein modifying the size of the secure area is performed in response to a request by a user.

3. The method as set forth in claim 2, wherein modifying the size of the secure area in response is performed automatically in accordance with a memory management policy.

4. The method as set forth in claim 1, wherein the authentication process between the host and the secure storage device is carried out by a cryptographic protocol.

5. The method as set forth in claim 1, further comprising backing up data from the user area to the host in preparation for modifying the size of the secure area.

6. The method as set forth in claim 1, further comprising formatting the secure area after updating the management information.

7. The method as set forth in claim 6, wherein the secure storage device formats the modified secure area.

8. The method as set forth in claim 1, wherein backing up the secure data comprises encoding the secure data and transferring the encoded secure data to the host.

9. The method as set forth in claim 8, further comprising decoding the encoded secure data and storing the decoded secure data in the modified secure area.

10. A secure storage device for use by a host, the secure storage device comprising:
a flash memory with a secure area; and
a secure memory controller that is configured to control the flash memory and to enable access to the secure area based on authentication with the host.

11. The secure storage device as set forth in claim 10, wherein the secure memory controller comprises a secure flash translation layer module,
wherein the secure flash translation layer module comprises:
a host interface layer configured to receive a request of the host;
a trusted entity configured to conduct an authentication process through a cryptographic protocol with the host if the request is for secure data;
an access control layer configured to permit the trusted entity to access the secure area in response to a successful authentication; and
a flash translation layer configured to perform reading and writing operations with an address and data, which are transferred from the trusted entity, based on mapping information about the secure area.

12. The secure storage device as set forth in claim 11, wherein the secure flash translation layer module is configured to inform the host that it is impossible to access the secure area if the authentication process is not successful.

13. The secure storage device as set forth in claim 11, wherein the trusted entity of the secure flash translation layer is configured to authenticate a trusted entity of the host using the cryptographic protocol.

14. The secure storage device as set forth in claim 11, wherein the trusted entity of the secure flash translation layer module comprises:
a key storage layer configured to store a cryptographic key for use with the cryptographic protocol; and
a secure file system configured to format the secure area.

15. The secure storage device as set forth in claim 11, wherein secure flash translation layer module is configured to perform the authentication process between the host and the trusted entity by means of the cryptographic protocol.

16. The secure storage device as set forth in claim 15, wherein the secure flash translation layer module is configured to modify the size of the secure area in response to a request of a user for modification that is transferred from the host.

17. The secure storage device as set forth in claim 16, wherein the secure flash translation layer module is configured to modify the size of the secure area in response to a request for modification that is automatically transferred from the host.

18. A method of managing a secure storage device including a secure area and a user area, the method comprising:
storing management information regarding sizes of the secure area and the user area in a meta area of the secure storage device; and
modifying the management information in the meta area to resize the secure area and the user area in response to a request from a host.

19. The method of claim 18, further comprising:
performing an authentication process between the host and the secure storage device in preparation for modifying the size of the secure area.

20. The method of claim 19, further comprising:
backing up secure data stored in the secure area to the host after successfully completing the authentication process; and
storing the secure data, which was backed up to the host, into the secure area after resizing the secure area.
